(19) United States
(12) Patent Application Publication
(10) Pub. No.: US 2025/0139496 A1
(43) Pub. Date: May 1, 2025

(54) DETECTING DROP TYPE SURFACE

(71) Applicant: STMicroelectronics International N.V., Geneva (CH)

(72) Inventors: Tae-gil Kang, Seoul (KR); Hyeok Won, Ui-Wang (KR); Junyeong Ji, Seoul (KR); Sanghyuk Park, Seoul (KR)

(21) Appl. No.: 18/495,259

(22) Filed: Oct. 26, 2023

(51) Int. Cl. G06N 20/00; G01P 1/00; G01P 15/08; G01P 15/18

(52) U.S. Cl. CPC G06N 20/00; G01P 1/00; G01P 15/08; G01P 15/18

(57) ABSTRACT

According to an embodiment, a method for determining whether a fall of a device is on a hard surface or a soft surface is proposed. The method includes collecting N samples of acceleration data after detecting a free-fall event; applying a high-pass filter on the N samples of acceleration data; calculating a variance from the N samples of acceleration data after applying the high-pass filter on the N samples of acceleration data; determining that the fall is on the hard surface in response to the variance from the N samples of acceleration data after applying the high-pass filter on the N samples of acceleration data being greater than a threshold; and determining that the fall is on the soft surface in response to the variance from the N samples of acceleration data after applying the high-pass filter on the N samples of acceleration data being less than the threshold.

### TECHNICAL FIELD

The present disclosure generally relates to sensors and, in particular embodiments, to detecting drop type surfaces using a sensor.

### BACKGROUND

Enabling retrospective surface detection on mobile devices, such as tablets, cellular devices, and the like, carries several significant advantages. Firstly, it facilitates post-incident analysis, enabling users and device manufacturers to review data on fall surfaces. This data can provide invaluable insights into the common occurrences and locations of accidents, informing the design of more durable and resilient products less prone to fall damage. Additionally, it is a valuable resource for market research, allowing manufacturers to gather anonymized data on fall surfaces to gain deeper insights into user behavior and accident trends. This information can guide the development of new features, accessories, and safety measures that align better with user preferences and needs.

Furthermore, this capability offers a means for user feedback and safety improvements. By recognizing patterns of falls on hard surfaces, the device can prompt users to consider protective measures like using cases or modifying their handling habits, thus proactively enhancing user education and preventing damage. Moreover, by identifying fall surfaces retrospectively, the device can encourage users to adopt preventive measures to avoid future falls, including recommending safety precautions like wrist straps or protective pouches. This ultimately extends the device's lifespan and reduces the frequency of replacements.

Additionally, the device's ability to determine fall surfaces after an incident enables more accurate damage assessment. This clarity benefits users seeking repairs or warranty claims by providing a clearer understanding of the damage's extent, facilitating smoother interactions with service providers. It also serves as valuable documentation for insurance and warranty purposes, aiding in dispute resolution and streamlining the claims process.

Enhanced data security is another crucial advantage. The device can initiate additional security measures, such as locking or encrypting data, based on the detected fall surface post-incident. This added layer of protection ensures that sensitive information remains secure after a fall, even if the user initially dismissed these actions.

Moreover, tailoring responses to falls based on post-incident surface detection is a noteworthy benefit. For example, if the device detects a fall on a soft surface, it might provide a less urgent notification or take less drastic actions. Conversely, falls on hard surfaces could prompt a more immediate and urgent response, potentially preventing further damage or loss.

Furthermore, post-incident surface detection contributes to an enhanced user experience. Users can gain a better understanding of their typical device usage patterns and locations, enabling them to make more informed choices about how they use and handle their devices. This, in turn, contributes to an overall improved user experience.

Thus, the ability of a mobile device to detect fall surfaces after the fact offers a wide range of advantages, including improved product design, enhanced user education, accurate damage assessment, heightened data security, tailored responses, prolonged device lifespan, enhanced user experiences, streamlined claims processes, and valuable market insights. It would be advantageous to differentiate between the type of surface on which a device has fallen.

### SUMMARY

Technical advantages are generally achieved by embodiments of this disclosure, which describe detecting drop type surfaces using a sensor.

A first aspect relates to a method for determining whether a fall of an electronic device is on a hard surface or a soft surface. The method includes collecting N samples of acceleration data after detecting a free-fall event; calculating a number of crossing events from the N samples of acceleration data, the number of crossing events corresponding to a number of times an acceleration norm calculation for each sample of the N samples exceeds a first threshold; determining that the fall is on the hard surface in response to the number of crossing events being greater than a second threshold; and determining that the fall is on the soft surface in response to the number of crossing events being less than the second threshold.

A second aspect relates to a method for determining whether a fall of an electronic device is on a hard surface or a soft surface. The method includes collecting N samples of acceleration data after detecting a free-fall event; applying a high-pass filter on the N samples of acceleration data; calculating a variance from the N samples of acceleration data after applying the high-pass filter on the N samples of acceleration data; determining that the fall is on the hard surface in response to the variance from the N samples of acceleration data after applying the high-pass filter on the N samples of acceleration data being greater than a threshold; and determining that the fall is on the soft surface in response to the variance from the N samples of acceleration data after applying the high-pass filter on the N samples of acceleration data being less than the threshold.

A third aspect relates to a sensor of an electronic device. The sensor includes an accelerometer configured to collect acceleration data; a finite state machine circuit configured to receive the acceleration data from the accelerometer and detect a free-fall event; and a machine learning core, in response to detecting the free-fall event, configured to: calculate a number of crossing events from N samples of acceleration data collected after the free-fall event, the number of crossing events corresponding to a number of times an acceleration norm calculation for each sample of the N samples exceeds a first threshold, determine that a fall of the electronic device is on a hard surface in response to the number of crossing events being greater than a second threshold, and determine that the fall is on a soft surface in response to the number of crossing events being less than the second threshold.

A fourth aspect relates to a sensor of an electronic device. The sensor includes an accelerometer configured to collect acceleration data; a finite state machine circuit configured to receive the acceleration data from the accelerometer and detect a free-fall event; and a machine learning core, in response to detecting the free-fall event, configured to: apply a high-pass filter on N samples of acceleration data collected after the free-fall event, calculate a variance from the N samples of acceleration data after applying the high-pass filter on the N samples of acceleration data, determine that a fall of the electronic device is on a hard surface in response to the variance from the N samples of acceleration data after applying the high-pass filter on the N samples of acceleration data being greater than a threshold, and determine that the fall is on a soft surface in response to the variance from the N samples of acceleration data after applying the high-pass filter on the N samples of acceleration data being less than the threshold.

A fifth aspect relates to an electronic device having a sensor, the sensor including an accelerometer configured to collect acceleration data; a finite state machine circuit configured to receive the acceleration data from the accelerometer and detect a free-fall event; and a machine learning core, in response to detecting the free-fall event, configured to: calculate a number of crossing events from N samples of acceleration data collected after the free-fall event, the number of crossing events corresponding to a number of times an acceleration norm calculation for each sample of the N samples exceeds a first threshold, determine that a fall of the electronic device is on a hard surface in response to the number of crossing events being greater than a second threshold, and determine that the fall is on a soft surface in response to the number of crossing events being less than the second threshold.

A sixth aspect relates to an electronic device having a sensor, the sensor including an accelerometer configured to collect acceleration data; a finite state machine circuit configured to receive the acceleration data from the accelerometer and detect a free-fall event; and a machine learning core, in response to detecting the free-fall event, configured to: apply a high-pass filter on N samples of acceleration data collected after the free-fall event, calculate a variance from the N samples of acceleration data after applying the high-pass filter on the N samples of acceleration data, determine that a fall of the electronic device is on a hard surface in response to the variance from the N samples of acceleration data after applying the high-pass filter on the N samples of acceleration data being greater than a threshold, and determine that the fall is on a soft surface in response to the variance from the N samples of acceleration data after applying the high-pass filter on the N samples of acceleration data being less than the threshold.

A seventh aspect relates to a method for determining whether a fall of an electronic device is on a hard surface or a soft surface. The method including collecting N samples of acceleration data after detecting a free-fall event; applying a high-pass filter on the N samples of acceleration data; calculating a first variance value from the N samples of acceleration data after applying the high-pass filter on the N samples of acceleration data; calculating an energy value, a mean value, and a second variance value for the N samples of acceleration data; and determining that the fall is on the hard surface or the soft surface based on the first variance value, the second variance value, the energy value, and the mean value.

An eight aspect relates to a method for determining whether a fall of an electronic device is on a hard surface or a soft surface. The method including collecting N samples of acceleration data after detecting a free-fall event; calculating a number of crossing events from the N samples of acceleration data, the number of crossing events corresponding to a number of times an acceleration norm calculation for each sample of the N samples exceeds a first threshold and a second threshold, the first threshold being equal to sum of a hysteresis value and a mean value for M samples of acceleration data collected before the crossing event, the second threshold being equal to the difference between the mean value and the hysteresis value; determining that the fall is on the hard surface in response to the number of crossing events being greater than a third threshold; and determining that the fall is on the soft surface in response to the number of crossing events being less than the third threshold.

A ninth aspect relates to an electronic device having a sensor, the sensor including an accelerometer configured to collect acceleration data; a finite state machine circuit configured to receive the acceleration data from the accelerometer and detect a free-fall event; and a machine learning core, in response to detecting the free-fall event, configured to: calculate a number of crossing events from the N samples of acceleration data, the number of crossing events corresponding to a number of times an acceleration norm calculation for each sample of the N samples exceeds a first threshold and a second threshold, the first threshold being equal to the sum of a hysteresis value and a mean value for M samples of acceleration data collected before the crossing event, the second threshold being equal to the difference between the mean value and the hysteresis value, determine that a fall of the electronic device is on a hard surface in response to the number of crossing events being greater than a third threshold, and determine that the fall is on a soft surface in response to the number of crossing events being less than the third threshold.

A tenth aspect relates to an electronic device having a sensor, the sensor including an accelerometer configured to collect acceleration data; a finite state machine circuit configured to receive the acceleration data from the accelerometer and detect a free-fall event; and a machine learning core, in response to detecting the free-fall event, configured to: calculate a number of crossing events from the N samples of acceleration data, the number of zero-crossing events corresponding to a number of times an acceleration norm calculation for each sample of the N samples exceeds a first threshold and a second threshold, the first threshold being equal to sum of a hysteresis value and a mean value for M samples of acceleration data collected before the crossing event, the second threshold being equal to the difference between the mean value and the hysteresis value, determine that a fall of the electronic device is on a hard surface in response to the number of crossing events being greater than a third threshold, and determine that the fall is on a soft surface in response to the number of crossing events being less than the third threshold.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a block diagram of an embodiment system;

FIG. 2 is a block diagram of an embodiment sensor;

FIG. 3 illustrates a flow chart of a method for free-fall calculation;

FIG. 4 illustrates a flow chart of an embodiment method for determining whether the electronic device has fallen on a hard or a soft surface;

FIG. 5 is a flow chart of an embodiment method for determining whether the electronic device has fallen on a hard surface or a soft surface;

FIG. 6 is a flow chart of an embodiment method for determining whether the electronic device has fallen on a hard surface or a soft surface;

FIG. 7 is a flow chart of an embodiment method for operating the sensor of FIG. 2 to determine a free-fall event and detect whether the drop is on a hard or soft surface;

FIG. 8 is a flow chart of an embodiment method for operating the sensor of FIG. 2 to determine a free-fall event and detecting whether the drop is on a hard or soft surface; and

FIG. 9 is a flow chart of an embodiment method for operating the sensor of FIG. 2 to determine a free-fall event and detect whether the drop is on a hard or soft surface.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

While the inventive aspects are described primarily in the context of a mobile device, it should also be appreciated that these inventive aspects may also apply to other electronic or non-electronic devices equipped with an accelerometer. In particular, aspects of this disclosure may similarly apply to, for example, packaging equipment, shipping equipment, or the like. For example, a shipping company may affix a sensor to a package during shipment to monitor in real-time or after the fact if the package was dropped and whether the drop corresponded to a drop on a soft surface or a hard surface. The shipping company may use this information for insurance purposes or to improve their service.

In a repair shop, engineers often lack information about why a customer's device is broken; they can only observe the symptoms. In cases involving broken glass, it's evident that the device has suffered significant damage, usually due to the customer's fault. However, in other instances, unless customers admit their mistakes, the causes behind non-functional components in the damaged device remain unknown. This can lead to a distinction between customer-paid and original equipment manufacturer (OEM) covered repairs. Many OEM companies have implemented drop detection solutions on cell phones to monitor user drop events and track dropped distances, collecting this data for statistical purposes. However, the current solutions cannot differentiate between a drop on a hard surface (i.e., hard drop) that may cause damage to the device, such as dropping on a stone or concrete floor, and a drop on a soft surface (i.e., soft drop) that typically result in no damage, like dropping on a couch, bed, or soft carpet.

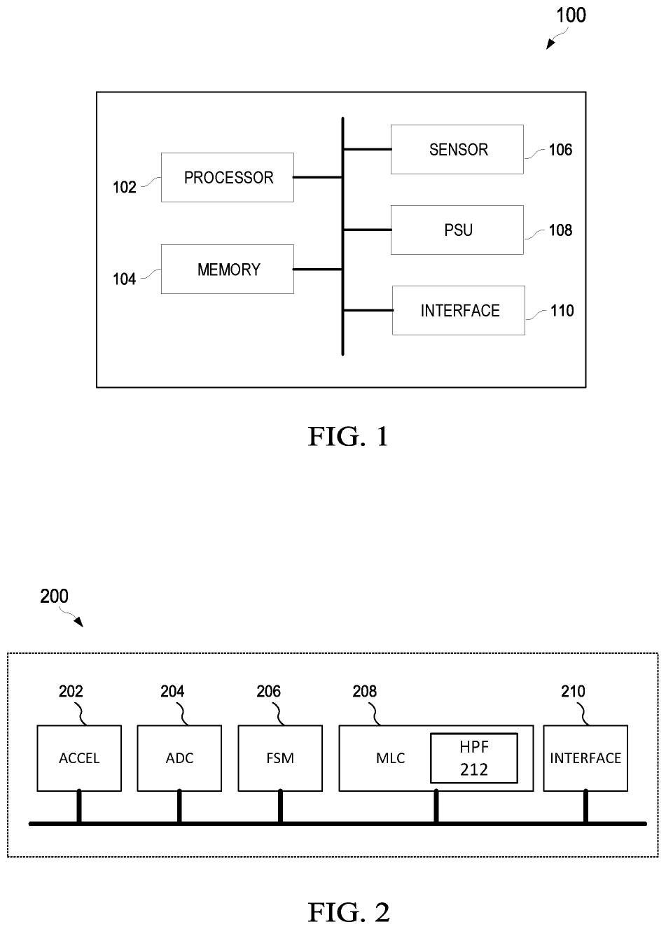

FIG. 1 illustrates a block diagram of an embodiment system 100. System 100 includes a processor 102, a memory 104, a sensor 106, a power supply unit (PSU) 108, and an interface 110, which may (or may not) be arranged as shown. Although one of each (i.e., the processor 102, the memory 104, the sensor 106, the power supply unit 108, and the interface 110) is shown in FIG. 1, the number of components is not limiting, and greater numbers are similarly contemplated in other embodiments. System 100 may include additional components not depicted, such as long-term storage (e.g., non-volatile memory, etc.), power management circuitry, security and encryption modules (e.g., trusted platform modules (TPM), etc.), or the like. System 100 may be an electronic device, such as a smartphone, a tablet, a laptop, a smartwatch, a vehicle, or any system or sub-system capable of hosting the sensor 106.

In embodiments, each component can communicate with any other component internally within or external to the system 100. For example, each component can communicate using the I²C (Inter-Integrated Circuit), alternatively known as I2C or IIC, communication protocol, the 13C (Improved Inter Integrated Circuit) communication protocol, the serial peripheral interface (SPI) specification, or the like.

Processor 102 may be any component or collection of components adapted to perform computations or other processing-related tasks. In embodiments, processor 102 is an application processor or a microcontroller. Embodiments of this disclosure provide a solution whereby the continuous processing for monitoring a shock event is delegated from processor 102 to sensor 106. Conventionally, processor 102 or certain cores of processor 102 are continuously running to monitor for a shock event. As such, embodiments of this disclosure advantageously reduce power consumption within system 100 by shifting the workload from the processor 102 to the low-power, sensor 106, which operates at high efficiency and low power.

In embodiments, processor 102 receives meaningful data from sensor 106 such as shock intensity, duration, and type of surface causing the shock, which can be further processed by processor 102 to detect, for example, a car crash, a fall detection event, or used for warranty and insurance purposes.

Memory 104 may be any component or collection of components adapted to store programming or instructions for execution by processor 102. In an embodiment, memory 104 includes a non-transitory computer-readable medium.

Sensor 106, further described in FIG. 2, measures acceleration on system 100. In embodiments, sensor 106 continuously monitors for a free-fall event, with minimal to no intervention by processor 102. In embodiments, sensor 106 is configured to detect a free-fall event and the type of surface the system has fallen on by comparing values from an accelerometer of sensor 106 to one or more threshold values.

Power supply unit 108 may be any component or collection of components that provide power to the one or more components within the system 100. Power supply unit 108 may include various power management circuitry, charge storage components (i.e., battery), and the like.

Interface 110 may be any component or collection of components that allow processor 102 to communicate with other devices/components or a user. For example, interface 110 may be adapted to allow a user or sensor 106 to interact/communicate with the system 100. Further, interface 110 may include circuitry that allows system 100 to communicate signals to notify emergency contacts or trigger an automatic emergency response based on the type of surface the device has fallen on.

FIG. 2 illustrates a block diagram of an embodiment sensor 200, which may be implemented in system 100 as sensor 106. In embodiments, sensor 200 is an inertial measurement unit (IMU) type sensor. Sensor 200 includes an accelerometer 202, an analog-to-digital converter (ADC) 204, a finite state machine (FSM) circuit 206, a machine learning core (MLC) 208, and interfaces 210, which may (or may not) be arranged as shown. Sensor 200 may include additional components not shown. For example, sensor 200 may include a memory, a filtering circuit, or an intelligent sensor processing unit (ISPU) coupled to the memory.

In embodiments, the accelerometer 202 uses the principles of inertia, where the movement of proof masses within the device generates electrical signals proportional to the applied acceleration. Thus, the accelerometer 202 is configured to measure acceleration forces in various directions. In embodiments, accelerometer 202 can measure data along the X, Y, and Z axes. The finite state machine circuit 206, the machine learning core 208, or processor 102, for example, can be used to calculate the norm of the accelerometer data using equation (1):

$$acceleroter norm = \sqrt{{X}^{2} + {Y}^{2} + {Z}^{2}} .$$

In embodiments, the accelerometer 202 is a Micro-Electro-Mechanical System (MEMS) type of accelerometer. MEMS accelerometers are compact in size, have low power consumption, and with high precision.

The analog-to-digital converter 204 is configured to convert the analog voltage or current signals from the accelerometer 202 into a digital representation.

In embodiments, the machine learning core 208 includes a high-pass filter (HPF) 212 for high-pass filtering. In embodiments, the high-pass filter 212 is a second order infinite impulse response (IIR) filter. In embodiments, the machine learning core 208 uses default coefficients for high-pass filtering in the high-pass filter 212. In embodiments, the machine learning core 208 has configurable coefficients for high-pass filtering in the high-pass filter 212. The type of high-pass filtering of the high-pass filter 212 is non-limiting and various types of filtering, as known in the art, may be used. Further, although the high-pass filter 212 is shown here to be part of the machine learning core 208, this not limiting, and different implementations of the high-pass filter are contemplated in other embodiments. For example, the high-pass filter 212 may be a separate component of the sensor 200, a component within another component of the sensor 200, a component within a host device, or performed by a component in the host device.

In embodiments, one or more steps of the methods outlined below are implemented using the internal components within the sensor 200 in a host device. In such embodiments, the processor 102 of the host device can operate in a low-power operating mode. At the same time, the sensor 200 detects a free-fall event and determines whether the drop is on a hard or soft surface. Advantageously, such an implementation improves system efficiency by offloading work from the application processor to the sensor 200. These and additional details are further detailed below.

Conventionally, an accelerometer within a cell phone can detect a free-fall event and calculate the distance of the fall. An example of this process is detailed in the patent titled “System and method for determining the distance of free-fall,” issued as U.S. Pat. No. 11,255,875, incorporated by reference herein in its entirety.

As the device falls, the acceleration data along all three axes gradually decreases to zero. The solution calculates the time gap between the onset of zero acceleration (i.e., free-fall event) in all three axes and the first High Shock (HS) event, determining the distance the device has fallen. The time gap can be measured by counting the number of clock signals using, for example, a counter during the free-fall period before the HS event. Embodiments of this disclosure use the detected free-fall event before the first High Shock event to trigger the various steps outlined below to determine whether the device has fallen on a hard or soft surface.

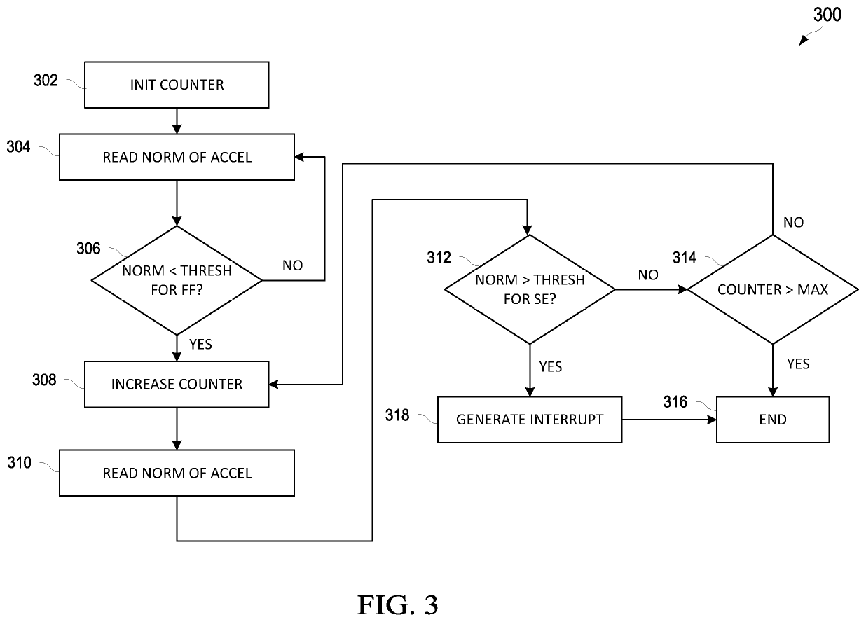

FIG. 3 illustrates a flow chart of a method 300 for free-fall calculation, as implemented, for example, by the finite state machine circuit 206. At step 302, the free-fall calculation begins by initializing a counter value. At step 304, the accelerator norm value is continuously calculated using equation (1) until its value falls below a free-fall threshold, indicating a free-fall event at step 306.

At step 308, the counter value is increased and at step 310, the accelerator norm value is calculated again. At step 312, the accelerator norm value is compared against a shock event threshold. At step 314, in response to the accelerator norm value being less than the shock event threshold, the counter value is compared to a maximum counter value. If the counter value is greater than the maximum counter value, the algorithm ends at step 316 without detecting a shock event.

However, suppose the counter value is less than the maximum counter value at step 314. In that case, the counter is again increased at step 308, the accelerator norm is again calculated at step 310, and its value is compared against the shock event (SE) threshold at step 312. When the calculated accelerator norm is determined to exceed the shock event threshold at step 312, an interrupt is generated at step 318 and the algorithm ends at step 316. The counter value in the latter instance can be used to determine the duration, drop distance, or the like.

Once a free-fall event is detected at step 306, embodiments of this disclosure provide a method and system to distinguish between a drop on a hard and soft surface. Specifically, when the free-fall event is detected, acceleration data is collected using the sensor 200 for a duration in time (i.e., window). In various embodiments, the samples collected within the window immediately after the free-fall event are used by, for example, the machine learning core 208 to decide whether the drop corresponds to a drop on a hard or a soft surface.

Generally, it is desirable to improve drop detection capabilities in an electronic device by developing a solution that can differentiate between a drop on a hard and soft surface. However, there is concern that any potential implementation may lead to increased power consumption if the detection process occurs on the host side with fast data streaming, requiring the device to occasionally wake up from sleep mode even when not in active use, resulting in system inefficiencies. Embodiments of this disclosure utilize embedded solutions in sensors to detect a drop and determine whether the drop is on a hard or soft surface. For example, aspects of this disclosure utilize the machine learning core 208, the finite state machine circuit 206, or the intelligent sensor processing unit (ISPU), individually or in combination, to process data and make drop-type detections.

It is observed that dropping an electronic device on a soft surface, such as a couch, bed, or soft carpet, and a hard surface, like stone, asphalt, or concrete, results in distinct mechanical interactions that lead to differences in the device's physical behavior in response to the drop event. These disparities stem from, for example, the properties of the two surfaces, the impact of gravity, and the nature of the materials involved.

When a device falls on a hard surface (i.e., after the shock event has been detected), the variance in the behavior of the accelerator norm calculation over time is generally greater than when it lands on a soft surface. Hard surfaces transmit impact energy more efficiently, causing unpredictable bouncing and ricocheting. The device can hit the ground at various angles, which makes the impact less predictable compared to a soft surface, where it tends to sink and settle upon impact, minimizing the bouncing effect.

The magnitude (or modulus) of the acceleration vector, denoted as “∥a∥” or “a,” represents the size or absolute value of the acceleration. In mathematical terms, it is a scalar quantity that measures how much an object's velocity changes and is expressed in units such as meters per second squared (m/s²) in the International System of Units (SI).

In embodiments, to calculate the magnitude of the acceleration vector at each instance in time (t), one can use the equation (2.1): XLₜ=\sqrt{X(t)²+Y(t)²+Z(t)²}, where X(t) is the acceleration component in the x direction at time t, Y(t) is the acceleration component in the y direction at time t, and Z(t) is the acceleration component in the z direction at time t.

In embodiments, to calculate the magnitude of the acceleration vector at each instance in time (t), one can use equation (2.2): XLₜ²=X(t)²+Y(t)²+Z(t)². Advantageously, by using XLₜ² instead of XL(t), the calculation time can be optimized.

The stream of the magnitude of the acceleration vector for N samples can be represented as equation (3): XLₖ=XL(tₖ)k=0,1, . . . . N−1. The number of samples (i.e., N) corresponds to the number of samples collected after the free-fall event. In embodiments, the number of samples (i.e., N) is configurable. In embodiments, the number of samples (i.e., N) can be configured by adjusting the window under observation immediately after a free-fall event detection.

Further, the mean of the accelerator norm calculation over time for a device landing on a soft surface is typically higher than on a hard surface. This is because softer surfaces deform and cushion the impact, spreading the force over a slightly longer duration. On the contrary, hard surfaces are rigid and unforgiving, resulting in a higher peak force upon impact.

Based on these physical behaviors, the mean of the acceleration vector (μ_{XL}), the energy of the acceleration vector (E_{XL}), and the variance of the acceleration vector (σ_{XL}²) for the N samples after the free-fall event detection can be used to distinguish between a drop on a hard and soft surface.

The mean of the acceleration vector (μ_{XL}) for the N samples can be represented as equation (4):

$${μ}_{X L} = \frac{1}{N} {\sum }_{i = 0}^{N - 1} X {L}_{k} .$$

The energy of the acceleration vector (E_{XL}) for the N samples can be represented as equation (5): E_{XL}=Σᵢ₌₀^{N-1}XLₖ².

The variance of the acceleration vector (σ_{XL}²) for the N samples can be represented as equation (6):

$${σ}_{X L}^{2} = \frac{1}{N} {\sum }_{i = 0}^{N - 1} {( X {L}_{k} - {μ}_{X L} )}^{2} .$$

Based on equations (4), (5), and (6), it can be observed that the variance (σ_{XL}²) can also be represented by the mean (μ_{XL}) and energy (E_{XL}), as shown in equation (7):

$${σ}_{X L}^{2} = \frac{{E}_{X L}}{N} - {μ}_{XL}^{2} .$$

Moreover, an application of a high-pass filter to the electronic device's acceleration vector, one can selectively pass high-frequency components of the acceleration signal while attenuating or filtering out lower-frequency components (e.g., DC bias). One primary outcome of high-pass filtering is the removal of low-frequency components from the acceleration vector, meaning that gradual or slow changes in acceleration are effectively eliminated from the signal. This type of filtering can be particularly valuable when one wants to focus on rapid changes or sudden movements in an object's motion while disregarding any slow, steady-state motions.

Another key advantage in applying a high-pass filter is the emphasis on rapid changes in acceleration. High-pass filtering highlights quick accelerations or decelerations in an object's motion. This feature becomes useful to detect and analyze abrupt events, such as impacts, collisions, or rapid changes in direction during an experiment or study.

Furthermore, a high-pass filter can assist in reducing the impact of low-frequency noise or interference in the acceleration data. Noise often manifests as slow, continuous variations in the signal, and a high-pass filter effectively cleans up the data by removing these unwanted low-frequency components.

The mean of the high-pass filter applied to the acceleration vector (μ_{f,XL}) for the N samples can be represented as equation (8):

$${μ}_{f , XL} = \frac{1}{N} {\sum }_{i = 0}^{N - 1} f , {XL}_{k} .$$

The energy of the high-pass filter applied to the acceleration vector (E_{f,XL}) for the N samples can be represented as equation (9): E_{f,XL}=Σᵢ₌₀^{N-1}f,XLₖ².

The variance of the high-pass filter applied to the acceleration vector (σ_{f,XL}²) for the N samples can be represented as equation (10):

$${σ}_{f , XL}^{2} = \frac{1}{N} {\sum }_{i = 0}^{N - 1} {( f , X {L}_{k} - {μ}_{f , XL} )}^{2} .$$

Based on equations (8), (9), and (10), it can be observed that the variance (σ_{f,XL}²) can also be represented by the mean (μ_{f,XL}) and energy (E_{f,XL}), as shown in equation (11):

$${σ}_{f , XL}^{2} = \frac{{E}_{f , XL}}{N} - {μ}_{f , XL}^{2} .$$

In an embodiment, the variance of the high-pass filter applied to the acceleration vector (σ_{f,XL}²) for the N samples within a defined window is compared to a high-pass filter variance threshold (σ_{f,THRESH}) to determine whether the device fell on a soft or a hard surface.

For example, if the variance of the high-pass filter applied to the acceleration vector (σ_{f,XL}²) for the N samples within a defined window is determined to be greater than the high-pass filter variance threshold (σ_{f,THRESH}), then a hard surface is detected; however, if the variance of the high-pass filter applied to the acceleration vector (σ_{f,XL}²) for the N samples within a defined window is determined to be less than the high-pass filter variance threshold (σ_{f,THRESH}), a soft surface is detected.

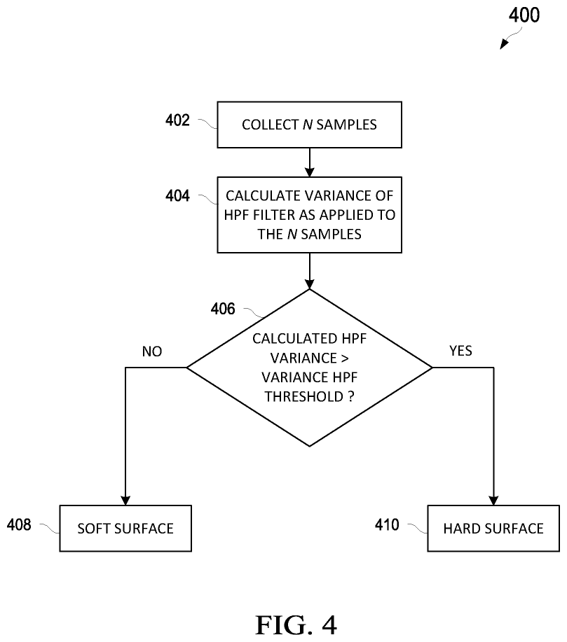

FIG. 4 illustrates a flow chart of an embodiment method 400 for determining whether the electronic device has fallen on a hard or a soft surface. Method 400 utilizes the variance of the high-pass filter as applied to the acceleration vector (σ_{f,XL}²) for the N samples of acceleration data collected after a free-fall event detection to make the determination of whether the electronic device has fallen on a hard or a soft surface.

At step 402, the acceleration data for the N samples are collected after a free-fall event detection. In embodiments, each sample is collected synchronously with each clock pulse generated by a clock signal.

At step 404, the variance of the high-pass filter as applied to the acceleration vector (σ_{f,XL}²) for the N samples of acceleration data collected after a free-fall event detection is calculated. In embodiments, the variance of the high-pass filter applied to the acceleration vector (σf,XL²) for the N samples is calculated using equation 10 or equation 11.

At step 406, the variance of the high-pass filter as applied to the acceleration vector (σ_{f,XL}²) for the N samples of acceleration data collected after a free-fall event detection is compared with a variance high-pass filter (HPF) threshold (σ_{f,THRESH}).

At step 408, if the variance of the high-pass filter as applied to the acceleration vector (σf,XL²) for the N samples of acceleration data collected after a free-fall event detection is less than the variance high-pass filter (HPF) threshold (σ_{f,THRESH}), a drop on a soft surface is detected. This condition can be represented as equation (13): σ_{f,XL}²<σ_{f,THRESH}→SOFT SURFACE.

At step 410, if the variance of the high-pass filter as applied to the acceleration vector (σ_{f,XL}) for the N samples of acceleration data collected after a free-fall event detection is greater than the variance high-pass filter (HPF) threshold (σ_{f,THRESH}), a drop on a hard surface is detected. This condition can be represented as equation (14): σ_{f,XL}²>σ_{f,THRESH}→HARD SURFACE.

In embodiments, steps 402-410 are performed by the machine learning core 208 of sensor 200.

In the scenario of an object falling towards a surface and subsequently bouncing off it, several phases of motion can be observed, each with distinct characteristics of acceleration. Initially, when the object is in free-fall before it contacts the surface, its acceleration is directed downward (i.e., towards the Earth), typically at a constant rate equal to the acceleration due to gravity (approximately 9.81 m/s² near the Earth's surface). During this phase, the object's acceleration vector is negative, indicating that the object's velocity is continuously increasing in the downward direction. No zero-crossing of the acceleration vector occurs during this phase, as the object experiences a constant acceleration due to gravity.

However, when the object collides with the surface, there is a sudden change in its velocity. During this collision phase, the acceleration vector changes direction and becomes positive, pointing upward. This positive acceleration signifies a rapid deceleration of the object upon impact, effectively causing the object to momentarily come to rest in terms of its downward velocity. It is at this point that the acceleration vector crosses zero, marking the transition from a downward motion to an upward rebound.

As the object begins to rebound from the surface, the acceleration vector remains positive, indicating that the object is now accelerating upward. The magnitude of the acceleration gradually decreases as the object loses speed during its ascent. Eventually, the object reaches its highest point during the rebound, at which the acceleration vector crosses zero once again, corresponding to the object briefly coming to rest at its highest point before it begins its descent back towards the surface.

During the descending phase, as the object moves downward again, the acceleration vector becomes negative once more, pointing downward due to the force of gravity. The acceleration vector gradually increases in magnitude as the object accelerates downward, but again there are no zero-crossings during this phase.

The object once more makes contact with the surface, and whether it undergoes additional rebounding, descending, and colliding phases or not depends on the characteristics of the surface. Eventually, it will come to a complete stop and settle into a resting position on the surface.

It has been observed that the number of zero-crossing events for the N samples of acceleration data collected after a free-fall event detection is greater for a hard surface than a soft one. When an electronic device strikes a hard surface, it can bounce off due to the lack of absorption. This bounce introduces more zero-crossing points as the device rebounds, potentially causing additional impacts and increasing the chances of damage. On a soft surface, the device is less likely to bounce significantly, reducing the occurrence of zero-crossings and minimizing secondary impacts.

In an embodiment, the zero-crossing of the acceleration norm value corresponds to the number of times the acceleration norm calculation exceeds a threshold within a defined window. Once the number of zero-crossings has been determined within the defined window, it can be compared to a zero-crossing threshold (ZC_{TH}) that differentiates between a soft surface and a hard surface. For example, if the zero-crossing threshold (ZC_{TH}) is set to twelve, and the number of zero-crossings of the acceleration norm within the defined window is determined to be greater than twelve, then a hard surface is detected; however, if the number of zero-crossings of the acceleration norm within the defined window is determined to be less than twelve, a soft surface is detected.

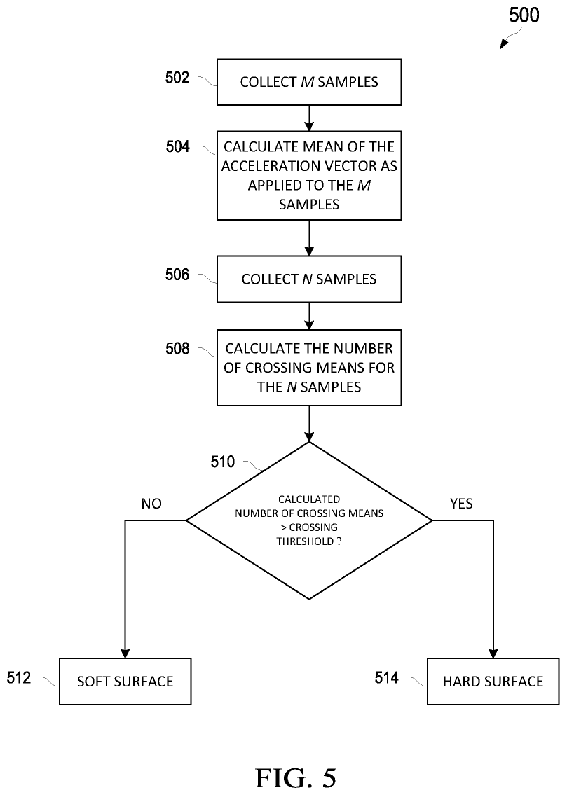

FIG. 5 illustrates a flow chart of an embodiment method 500 for determining whether the electronic device has fallen on a hard surface or a soft surface. Method 500 utilizes the number of zero-crossing events for the N samples of acceleration data collected after a free-fall event detection to make the determination of whether the electronic device has fallen on a hard or a soft surface.

The number of occurrences of a selected number of samples crossing a threshold can be used to determine the number of crossing events. The threshold can be defined as the sum of the average value computed in a previous window and a predetermined or configurable hysteresis value. The average value can be computed for M samples of data. A first threshold can be set to the average value plus the hysteresis value and a second threshold can be set to the average value minus the hysteresis value. The number of times the N samples of acceleration data cross the first threshold and the second threshold can be used to determine the number of crossing events.

At step 502, the acceleration data for M samples are collected. In embodiments, each sample is collected synchronously with each clock pulse generated by a clock signal. In embodiments, the number M is equal to the number N.

At step 504, the average value for the M samples of data is computed. In embodiments, the hysteresis value is selected to be equal to zero. In such embodiments, only a single threshold is used, which is equal to the computed average value for the M samples of data.

At step 506, the acceleration data for N samples are collected after the M samples are collected. At step 508, the number of crossing events (ZC_{XL}) for the N samples of acceleration data collected after the M samples are collected is calculated based on the first and second thresholds. In embodiments, where the hysteresis value is selected to be equal to zero, only a single threshold is used to determine the number of crossing events (ZC_{XL}) for the N samples of acceleration data collected after the M samples are collected.

At step 510, the number of crossing events (ZC_{XL}) for the N samples of acceleration data collected after a free-fall event detection is compared with a crossing threshold (ZC_{TH}).

At step 512, if the number of crossing events (ZC_{XL}) for the N samples of acceleration data collected after a free-fall event detection is less than the crossing threshold (ZC_{TH}), a drop on a soft surface (i.e., soft drop) is detected. This condition can be represented as equation (15): ZC_{XL}≤ZC_{TH}→SOFT SURFACE.

At step 510, if the number of crossing events (ZC_{XL}) for the N samples of acceleration data collected after a free-fall event detection is greater than the crossing threshold (ZC_{TH}), a drop on a hard surface is detected. This condition can be represented as equation (16): ZC_{XL}>ZC_{TH}→HARD SURFACE.

In embodiments, steps 502-514 are performed by the machine learning core 208 of sensor 200.

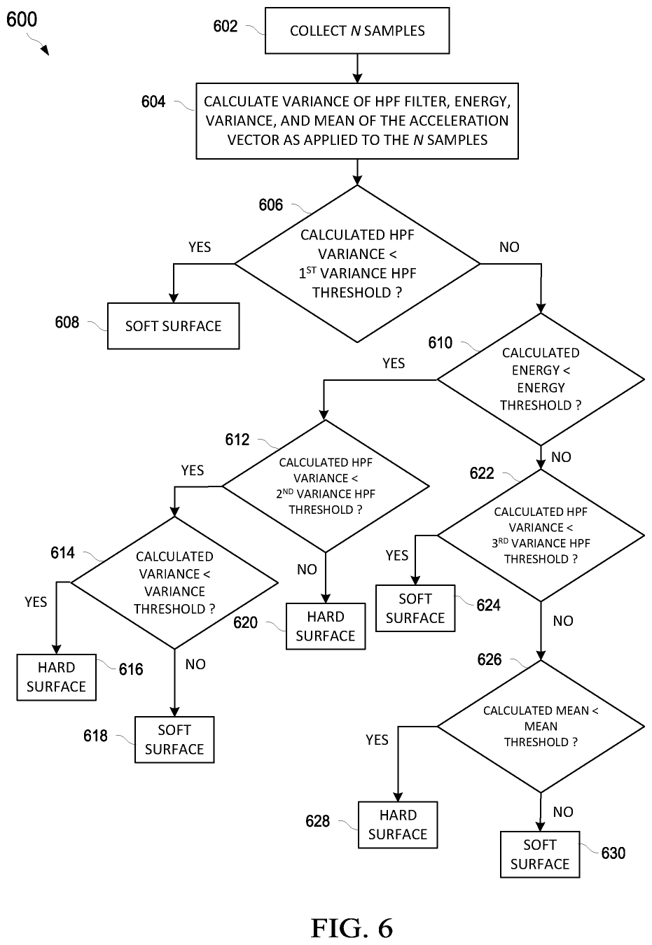

FIG. 6 illustrates a flow chart of an embodiment method 600 for determining whether the electronic device has fallen on a hard surface or a soft surface. Method 600 utilizes the variance of the high-pass filter as applied to the acceleration vector (σ_{f,XL}²), the energy of the acceleration vector (E_{XL}), the variance of the acceleration vector (σ_{XL}²), and the mean of the acceleration vector (μ_{XL}) for the N samples of acceleration data collected after a free-fall event detection to make the determination of whether the electronic device has fallen on a hard or a soft surface.

At step 602, the acceleration data for the N samples are collected after a free-fall event detection. In embodiments, each sample is collected synchronously with each clock pulse generated by a clock signal.

At step 604, the variance of the high-pass filter as applied to the acceleration vector (σ_{f,XL}²), the energy of the acceleration vector (E_{XL}), the variance of the acceleration vector (σ_{XL}²), and the mean of the acceleration vector (μ_{XL}) for the N samples of acceleration data are calculated after a free-fall event detection is calculated.

In embodiments, the variance of the high-pass filter applied to the acceleration vector (σ_{f,XL}²) for the N samples is calculated using equation 10 or equation 11.

In embodiments, the energy of the acceleration vector (E_{XL}) for the N samples is calculated using equation 5.

In embodiments, the variance of the acceleration vector (σ_{XL}²) for the N samples is calculated using equations 6 or 7.

In embodiments, the mean of the acceleration vector (μ_{XL}) for the N samples is calculated using equation 4.

At step 606, the variance of the high-pass filter as applied to the acceleration vector (σ_{f,XL}²) for the N samples of acceleration data collected after a free-fall event detection is compared with a first variance high-pass filter threshold (σ_{f,TH1}).

At step 608, if the variance of the high-pass filter as applied to the acceleration vector (σ_{f,XL}²) for the N samples of acceleration data collected after a free-fall event detection is less than the first variance high-pass filter threshold (σ_{f,TH1}), a drop on a soft surface is detected. This condition can be represented as equation (17): σ_{F,XL}²<σ_{f,TH1}→SOFT SURFACE.

At step 610, if the variance of the high-pass filter as applied to the acceleration vector (σ_{f,XL}²) for the N samples of acceleration data collected after a free-fall event detection is greater than the first variance high-pass filter threshold (σ_{f,TH1}), the energy of the acceleration vector (E_{XL}) for the N samples of acceleration data collected after a free-fall event detection is compared to an energy threshold (E_{TH}).

At step 612, if the energy of the acceleration vector (E_{XL}) for the N samples of acceleration data collected after a free-fall event detection is less than the energy threshold (E_{TH}), the variance of the high-pass filter as applied to the acceleration vector (σ_{f,XL}²) for the N samples of acceleration data collected after a free-fall event detection is compared with a second variance high-pass filter threshold (σ_{f,TH2}).

At step 614, if the variance of the high-pass filter as applied to the acceleration vector (σ_{f,XL}²) for the N samples of acceleration data collected after a free-fall event detection is less than the second variance high-pass filter threshold (σ_{f,TH2}), the variance of the acceleration vector (σ_{XL}²) for the N samples after a free-fall event detection is compared with a variance threshold (σ_{TH}).

At step 616, if the variance of the acceleration vector (σ_{XL}²) for the N samples after a free-fall event detection is less than the variance threshold (σ_{TH}), a drop on a hard surface is detected. This condition can be represented as equation (18): σ_{f,XL}²>σ_{f,TH1}& E_{XL}<E_{TH} & σ_{f,XL}²<σ_{f,TH2} & σ_{XL}²<σ_{TH}→HARD SURFACE.

At step 618, if the variance of the acceleration vector (σ_{XL}²) for the N samples after a free-fall event detection is greater than the variance threshold (σ_{TH}), a drop on soft surface is detected. This condition can be represented as equation (19): σ_{f,XL}²>[σ_{f,TH1}, σ_{f,TH2}] & E_{XL}<E_{TH}→HARD SURFACE.

At step 620, if the variance of the high-pass filter as applied to the acceleration vector (σ_{f,XL}²) for the N samples of acceleration data collected after a free-fall event detection is greater than the second variance high-pass filter threshold (σ_{f,TH2}), a drop on a hard surface is detected. This condition can be represented as equation (20): σ_{f,XL}²>[σ_{f,TH1}, σ_{f,TH2}] & E_{XL}<E_{TH}→HARD SURFACE.

At step 622, if the energy of the acceleration vector (E_{XL}) for the N samples of acceleration data collected after a free-fall event detection is greater than the energy threshold (E_{TH}), the variance of the high-pass filter as applied to the acceleration vector (σ_{f,XL}²) for the N samples of acceleration data collected after a free-fall event detection is compared with a third variance high-pass filter threshold (σ_{f,TH3}).

At step 624, if the variance of the high-pass filter as applied to the acceleration vector (σ_{f,XL}²) for the N samples of acceleration data collected after a free-fall event detection is less than the third variance high-pass filter threshold (σ_{f,TH3}), a drop on a soft surface is detected. This condition can be represented as equation (21): σ_{f,XL}²>σ_{f,TH1} & E_{XL}>E_{TH} & σ_{f,XL}²<σ_{f,TH3}→SOFT SURFACE.

At step 626, if the variance of the high-pass filter as applied to the acceleration vector (σ_{f,XL}²) for the N samples of acceleration data collected after a free-fall event detection is greater than the third variance high-pass filter threshold (σ_{f,TH3}), the mean of the acceleration vector (μ_{XL}) for the N samples of acceleration data collected after a free-fall event detection is compared to a mean threshold (μ_{TH}).

At step 628, if the mean of the acceleration vector (μ_{XL}) for the N samples of acceleration data collected after a free-fall event detection is less than the mean threshold (μ_{TH}), a drop on a hard surface is detected. This condition can be represented as equation (22): σ_{f,XL}²>[σ_{f,TH1}, σ_{f,TH3}] & E_{XL}>E_{TH} & μ_{XL}<μ_{TH}→HARD SURFACE.

At step 630, if the mean of the acceleration vector (μ_{XL}) for the N samples of acceleration data collected after a free-fall event detection is greater than the mean threshold (μ_{TH}), a drop on a soft surface is detected. This condition can be represented as equation (17): σ_{f,XL}²>[σ_{f,TH1}, σ_{f,TH3}] & E_{XL}>E_{TH} & μ_{XL}>μ_{TH}→SOFT SURFACE.

It is noted that the steps outlined in methods 400, 500, and 600 can be used individually or in combination to determine whether the drop is on a hard or soft surface.

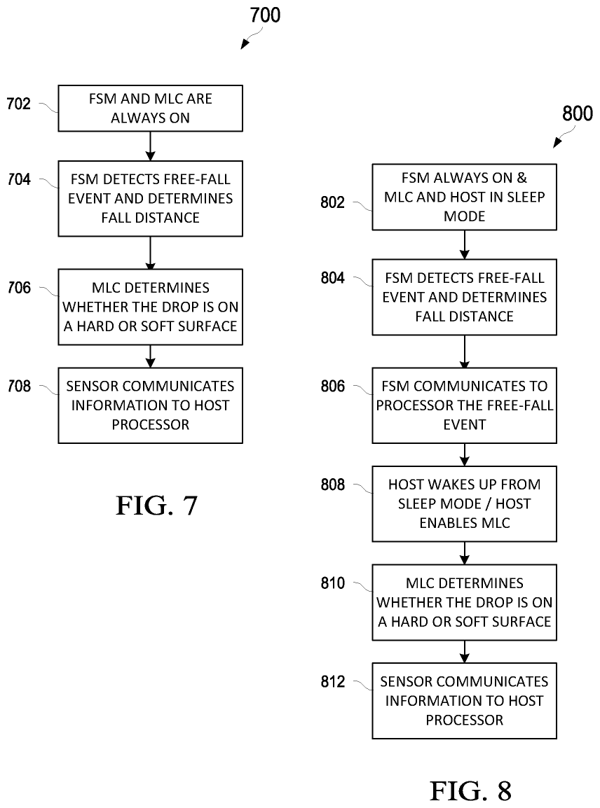

FIG. 7 illustrates a flow chart of an embodiment method 700 for operating the sensor 200 to determine a free-fall event and detect whether the drop is on a hard or soft surface. At step 702, the finite state machine circuit 206 and the machine learning core 208 are always ON. At step 704, the finite state machine circuit 206 is configured to detect the free-fall event and determine the distance the device has dropped using, for example, the method 300.

At step 706, the machine learning core 208 receives a signal from the finite state machine circuit 206, indicating a free-fall event, and implements the steps outlined in methods 400, 500, and 600. At step 708, once the machine learning core 208 determines that the drop is a drop on a soft or a hard surface, the information is communicated to, for example, an application processor in the host device.

FIG. 8 illustrates a flow chart of an embodiment method 800 for operating the sensor 200 to determine a free-fall event and detecting whether the drop is on a hard or soft surface. At step 802, the finite state machine circuit 206 is always ON and the machine learning core 208 is initially in a sleep mode. At step 804, the finite state machine circuit 206 is configured to detect the free-fall event and determine the distance the device has dropped using, for example, the method 300.

At step 806, in response to the finite state machine circuit 206 detecting a free-fall event, the finite state machine circuit 206 generates a signal communicated with, for example, an application processor in the host device. At step 808, in response to receiving the signal, the host device is woken up from sleep mode. Further, the application processor enables the machine learning core in the sensor 200 in response to the signal. At step 810, the machine learning core 208 implement the steps outlined in methods 400, 500, and 600 after being enabled. At step 812, once the machine learning core 208 determines that the drop is a drop on a soft or a hard surface, the information is communicated to the application processor in the host device.

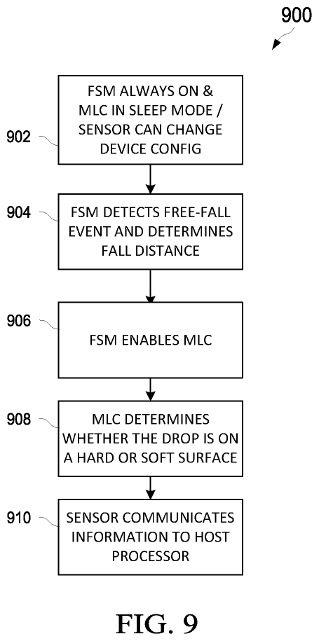

FIG. 9 illustrates a flow chart of an embodiment method 900 for operating the sensor 200 to determine a free-fall event and detect whether the drop is on a hard or soft surface. In embodiments, sensor 200 includes a finite state machine circuit 206 that can change the device configuration, such as in a sensor with adaptive self-configuration (ASC) mode, without needing an application processor in a host device.

At step 902, the finite state machine circuit 206 is always ON and the machine learning core 208 is initially in a sleep mode. At step 904, the finite state machine circuit 206 is configured to detect the free-fall event and determine the distance the device has dropped using, for example, the method 300.

At step 906, in response to the finite state machine circuit 206 detecting a free-fall event, the finite state machine circuit 206 enables the machine learning core 208. At step 908, the machine learning core 208 implements the steps outlined in methods 400, 500, and 600 after being enabled. At step 910, once the machine learning core 208 determines that the drop is a drop on a soft or a hard surface, the information is communicated to the application processor in the host device. Alternatively, at step 910, once the machine learning core 208 determines that the drop is a drop on a soft or a hard surface, the machine learning core 208 communication is limited to waking up the host device to communicate drops on a hard surface.

In embodiments, an intelligent sensor processing unit (ISPU) may perform all or a subset of the steps outlined in methods 700, 800, or 900.

In embodiments, sensor 200 may include a memory to store the various thresholds for implementing the steps of methods 300, 400, 500, and 600. In embodiments, the various thresholds are configurable.

In embodiments, the finite state machine circuit 206 is configured to receive the digital representation of the acceleration data and implement the steps outlined in method 300. If the finite state machine circuit 206 detects a free-fall event, the machine learning core 208 can be used to determine whether the drop is on a hard or soft surface based on the steps outlined in methods 400, 500, or 600.

It is noted that all steps outlined in the flow charts of the various methods are not necessarily required and can be optional. Further, changes to the arrangement of the steps, removal of one or more steps and path connections, and addition of steps and path connections are similarly contemplated.

A first aspect relates to a method for determining whether a fall of an electronic device is on a hard surface or a soft surface. The method includes collecting N samples of acceleration data after detecting a free-fall event; calculating a number of crossing events from the N samples of acceleration data, the number of crossing events corresponding to a number of times an acceleration norm calculation for each sample of the N samples exceeds a first threshold; determining that the fall is on the hard surface in response to the number of crossing events being greater than a second threshold; and determining that the fall is on the soft surface in response to the number of crossing events being less than the second threshold.

In a first implementation form of the method according to the first aspect as such, the method further includes detecting the free-fall event by a finite state machine circuit of a sensor of the electronic device.

In a second implementation form of the method according to the first aspect as such or any preceding implementation form of the first aspect, the determining that the fall is on the hard surface or the soft surface comprises determining by a machine learning core of the sensor. The method further includes communicating surface type of the fall to a processor of the electronic device.

In a third implementation form of the method according to the first aspect as such or any preceding implementation form of the first aspect, the finite state machine circuit and the machine learning core are always ON, the finite state machine circuit communicates the free-fall event detection to the machine learning core, and, in response, the machine learning core determines whether the fall is on the hard surface or the soft surface.

In a fourth implementation form of the method according to the first aspect as such or any preceding implementation form of the first aspect, the finite state machine circuit is always ON and the machine learning core is initially in low-power mode, the finite state machine circuit communicates the free-fall event detection to the processor, and, in response, the electronic device enables the machine learning core and the machine learning core determines whether the fall is on the hard surface or the soft surface.

In a fifth implementation form of the method according to the first aspect as such or any preceding implementation form of the first aspect, the sensor can change device configurations independently from the processor, the finite state machine circuit is always ON and the machine learning core is initially in low-power mode. In response to the finite state machine circuit detecting the free-fall event, the finite state machine circuit enables the machine learning core and the machine learning core determines whether the fall is on the hard surface or the soft surface.

In a sixth implementation form of the method according to the first aspect as such or any preceding implementation form of the first aspect, the first threshold and the second threshold are stored in a memory storage of the electronic device. The first threshold and the second threshold are configurable threshold values.

A second aspect relates to a method for determining whether a fall of an electronic device is on a hard surface or a soft surface. The method includes collecting N samples of acceleration data after detecting a free-fall event; applying a high-pass filter on the N samples of acceleration data; calculating a variance from the N samples of acceleration data after applying the high-pass filter on the N samples of acceleration data; determining that the fall is on the hard surface in response to the variance from the N samples of acceleration data after applying the high-pass filter on the N samples of acceleration data being greater than a threshold; and determining that the fall is on the soft surface in response to the variance from the N samples of acceleration data after applying the high-pass filter on the N samples of acceleration data being less than the threshold.

In a first implementation form of the method according to the second aspect as such, the method further includes detecting the free-fall event by a finite state machine circuit of a sensor of the electronic device.

In a second implementation form of the method according to the second aspect as such or any preceding implementation form of the second aspect, the determining that the fall is on the hard surface or the soft surface comprises determining by a machine learning core of the sensor. The method further includes communicating surface type of the fall to a processor of the electronic device.

In a third implementation form of the method according to the second aspect as such or any preceding implementation form of the second aspect, the finite state machine circuit and the machine learning core are always ON, the finite state machine circuit communicates the free-fall event detection to the machine learning core, and, in response, the machine learning core determines whether the fall is on the hard surface or the soft surface.

In a fourth implementation form of the method according to the second aspect as such or any preceding implementation form of the second aspect, the finite state machine circuit is always ON and the machine learning core is initially in low-power mode, the finite state machine circuit communicates the free-fall event detection to the processor, and, in response, the electronic device enables the machine learning core and the machine learning core determines whether the fall is on the hard surface or the soft surface.

In a fifth implementation form of the method according to the second aspect as such or any preceding implementation form of the second aspect, the sensor can change device configurations independently from the processor, the finite state machine circuit is always ON and the machine learning core is initially in low-power mode. In response to the finite state machine circuit detecting the free-fall event, the finite state machine circuit enables the machine learning core and the machine learning core determines whether the fall is on the hard surface or the soft surface.

In a sixth implementation form of the method according to the second aspect as such or any preceding implementation form of the second aspect, the threshold is stored in a memory storage of the electronic device and the threshold is configurable.

A third aspect relates to a sensor of an electronic device. The sensor includes an accelerometer configured to collect acceleration data; a finite state machine circuit configured to receive the acceleration data from the accelerometer and detect a free-fall event; and a machine learning core, in response to detecting the free-fall event, configured to: calculate a number of crossing events from N samples of acceleration data collected after the free-fall event, the number of crossing events corresponding to a number of times an acceleration norm calculation for each sample of the N samples exceeds a first threshold, determine that a fall of the electronic device is on a hard surface in response to the number of crossing events being greater than a second threshold, and determine that the fall is on a soft surface in response to the number of crossing events being less than the second threshold.

In a first implementation form of the sensor according to the third aspect as such, the machine learning core is further configured to communicate surface type of the fall to a processor of the electronic device.

In a second implementation form of the sensor according to the third aspect as such or any preceding implementation form of the third aspect, the finite state machine circuit and the machine learning core are always ON, the finite state machine circuit communicates the free-fall event detection to the machine learning core, and, in response, the machine learning core determines whether the fall is on the hard surface or the soft surface.

In a third implementation form of the sensor according to the third aspect as such or any preceding implementation form of the third aspect, the finite state machine circuit is always ON and the machine learning core is initially in low-power mode, the finite state machine circuit communicates the free-fall event detection to the processor, and, in response, the electronic device enables the machine learning core and the machine learning core determines whether the fall is on the hard surface or the soft surface.

In a fourth implementation form of the sensor according to the third aspect as such or any preceding implementation form of the third aspect, the sensor can change device configurations independently from the processor, the finite state machine circuit is always ON and the machine learning core is initially in low-power mode. In response to the finite state machine circuit detecting the free-fall event, the finite state machine circuit enables the machine learning core and the machine learning core determines whether the fall is on the hard surface or the soft surface.

In a fifth implementation form of the sensor according to the third aspect as such or any preceding implementation form of the third aspect, the first threshold and the second threshold are stored in a memory storage of the electronic device, and the first threshold and the second threshold are configurable threshold values.

A fourth aspect relates to a sensor of an electronic device. The sensor includes an accelerometer configured to collect acceleration data; a finite state machine circuit configured to receive the acceleration data from the accelerometer and detect a free-fall event; and a machine learning core, in response to detecting the free-fall event, configured to: apply a high-pass filter on N samples of acceleration data collected after the free-fall event, calculate a variance from the N samples of acceleration data after applying the high-pass filter on the N samples of acceleration data, determine that a fall of the electronic device is on a hard surface in response to the variance from the N samples of acceleration data after applying the high-pass filter on the N samples of acceleration data being greater than a threshold, and determine that the fall is on a soft surface in response to the variance from the N samples of acceleration data after applying the high-pass filter on the N samples of acceleration data being less than the threshold.

A fifth aspect relates to an electronic device having a sensor, the sensor including an accelerometer configured to collect acceleration data; a finite state machine circuit configured to receive the acceleration data from the accelerometer and detect a free-fall event; and a machine learning core, in response to detecting the free-fall event, configured to: calculate a number of crossing events from N samples of acceleration data collected after the free-fall event, the number of crossing events corresponding to a number of times an acceleration norm calculation for each sample of the N samples exceeds a first threshold, determine that a fall of the electronic device is on a hard surface in response to the number of crossing events being greater than a second threshold, and determine that the fall is on a soft surface in response to the number of crossing events being less than the second threshold.

A sixth aspect relates to an electronic device having a sensor, the sensor including an accelerometer configured to collect acceleration data; a finite state machine circuit configured to receive the acceleration data from the accelerometer and detect a free-fall event; and a machine learning core, in response to detecting the free-fall event, configured to: apply a high-pass filter on N samples of acceleration data collected after the free-fall event, calculate a variance from the N samples of acceleration data after applying the high-pass filter on the N samples of acceleration data, determine that a fall of the electronic device is on a hard surface in response to the variance from the N samples of acceleration data after applying the high-pass filter on the N samples of acceleration data being greater than a threshold, and determine that the fall is on a soft surface in response to the variance from the N samples of acceleration data after applying the high-pass filter on the N samples of acceleration data being less than the threshold.

A seventh aspect relates to a method for determining whether a fall of an electronic device is on a hard surface or a soft surface. The method including collecting N samples of acceleration data after detecting a free-fall event; applying a high-pass filter on the N samples of acceleration data; calculating a first variance value from the N samples of acceleration data after applying the high-pass filter on the N samples of acceleration data; calculating an energy value, a mean value, and a second variance value for the N samples of acceleration data; and determining that the fall is on the hard surface or the soft surface based on the first variance value, the second variance value, the energy value, and the mean value.

In a first implementation form of the method according to the seventh aspect as such, the method further includes determining that the fall is on the soft surface in response to the first variance value being less than a first threshold.

In a second implementation form of the method according to the seventh aspect as such or any preceding implementation form of the seventh aspect, the method further includes determining that the fall is on the hard surface in response to the first variance value being greater than a first threshold, the energy value being less than a second threshold, the first variance value being less than a third threshold, and the second variance value being less than a fourth threshold.

In a third implementation form of the method according to the seventh aspect as such or any preceding implementation form of the seventh aspect, the method further includes determining that the fall is on the soft surface in response to the first variance value being greater than a first threshold, the energy value being less than a second threshold, the first variance value being less than a third threshold, and the second variance value being greater than a fourth threshold.

In a fourth implementation form of the method according to the seventh aspect as such or any preceding implementation form of the seventh aspect, the method further includes determining that the fall is on the hard surface in response to the first variance value being greater than a first threshold, the energy value being less than a second threshold.

In a fifth implementation form of the method according to the seventh aspect as such or any preceding implementation form of the seventh aspect, the method further includes determining that the fall is on the soft surface in response to the first variance value being greater than a first threshold, the energy value being greater than a second threshold, and the first variance value being less than a third threshold.

In a sixth implementation form of the method according to the seventh aspect as such or any preceding implementation form of the seventh aspect, the method further includes determining that the fall is on the hard surface in response to the first variance value being greater than a first threshold, the energy value being greater than a second threshold, and the mean value being less than a third threshold.

In a seventh implementation form of the method according to the seventh aspect as such or any preceding implementation form of the seventh aspect, the method further includes determining that the fall is on the soft surface in response to the first variance value being greater than a first threshold, the energy value being greater than a second threshold, and the mean value being greater than a third threshold.

In an eight implementation form of the method according to the seventh aspect as such or any preceding implementation form of the seventh aspect, the determining includes comparing the first variance value, the second variance value, the energy value, and the mean value to a set of threshold values to determine whether the fall is on the hard surface or the soft surface.

An eight aspect relates to a method for determining whether a fall of an electronic device is on a hard surface or a soft surface. The method including collecting N samples of acceleration data after detecting a free-fall event; calculating a number of crossing events from the N samples of acceleration data, the number of crossing events corresponding to a number of times an acceleration norm calculation for each sample of the N samples exceeds a first threshold and a second threshold, the first threshold being equal to sum of a hysteresis value and a mean value for M samples of acceleration data collected before the crossing event, the second threshold being equal to the difference between the mean value and the hysteresis value; determining that the fall is on the hard surface in response to the number of crossing events being greater than a third threshold; and determining that the fall is on the soft surface in response to the number of crossing events being less than the third threshold.

A ninth aspect relates to an electronic device having a sensor, the sensor including an accelerometer configured to collect acceleration data; a finite state machine circuit configured to receive the acceleration data from the accelerometer and detect a free-fall event; and a machine learning core, in response to detecting the free-fall event, configured to: calculate a number of crossing events from the N samples of acceleration data, the number of crossing events corresponding to a number of times an acceleration norm calculation for each sample of the N samples exceeds a first threshold and a second threshold, the first threshold being equal to the sum of a hysteresis value and a mean value for M samples of acceleration data collected before the crossing event, the second threshold being equal to the difference between the mean value and the hysteresis value, determine that a fall of the electronic device is on a hard surface in response to the number of crossing events being greater than a third threshold, and determine that the fall is on a soft surface in response to the number of crossing events being less than the third threshold.

A tenth aspect relates to an electronic device having a sensor, the sensor including an accelerometer configured to collect acceleration data; a finite state machine circuit configured to receive the acceleration data from the accelerometer and detect a free-fall event; and a machine learning core, in response to detecting the free-fall event, configured to: calculate a number of crossing events from the N samples of acceleration data, the number of zero-crossing events corresponding to a number of times an acceleration norm calculation for each sample of the N samples exceeds a first threshold and a second threshold, the first threshold being equal to sum of a hysteresis value and a mean value for M samples of acceleration data collected before the crossing event, the second threshold being equal to the difference between the mean value and the hysteresis value, determine that a fall of the electronic device is on a hard surface in response to the number of crossing events being greater than a third threshold, and determine that the fall is on a soft surface in response to the number of crossing events being less than the third threshold.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. A method for determining whether a fall of an electronic device is on a hard surface or a soft surface, the method comprising:
collecting N samples of acceleration data after detecting a free-fall event;
calculating a number of crossing events from the N samples of acceleration data, the number of crossing events corresponding to a number of times an acceleration norm calculation for each sample of the N samples exceeds a first threshold;
determining that the fall is on the hard surface in response to the number of crossing events being greater than a second threshold; and
determining that the fall is on the soft surface in response to the number of crossing events being less than the second threshold.

2. The method of claim 1, further comprising detecting the free-fall event by a finite state machine circuit of a sensor of the electronic device.

3. The method of claim 2, where the determining that the fall is on the hard surface or the soft surface comprises determining by a machine learning core of the sensor, the method further comprising communicating surface type of the fall to a processor of the electronic device.

4. The method of claim 3, wherein the finite state machine circuit and the machine learning core are always ON, wherein the finite state machine circuit communicates the free-fall event detection to the machine learning core, and, in response, the machine learning core determines whether the fall is on the hard surface or the soft surface.

5. The method of claim 3, wherein the finite state machine circuit is always ON and the machine learning core is initially in low-power mode, wherein the finite state machine circuit communicates the free-fall event detection to the processor, and, in response, the electronic device enables the machine learning core and the machine learning core determines whether the fall is on the hard surface or the soft surface.

6. The method of claim 3, wherein the sensor can change device configurations independently from the processor, wherein the finite state machine circuit is always ON and the machine learning core is initially in low-power mode, wherein, in response to the finite state machine circuit detecting the free-fall event, the finite state machine circuit enables the machine learning core and the machine learning core determines whether the fall is on the hard surface or the soft surface.

7. The method of claim 1, wherein the first threshold and the second threshold are stored in a memory storage of the electronic device, the first threshold and the second threshold being configurable threshold values.

8. A method for determining whether a fall of an electronic device is on a hard surface or a soft surface, the method comprising:
collecting N samples of acceleration data after detecting a free-fall event;
applying a high-pass filter on the N samples of acceleration data;
calculating a variance from the N samples of acceleration data after applying the high-pass filter on the N samples of acceleration data;
determining that the fall is on the hard surface in response to the variance from the N samples of acceleration data after applying the high-pass filter on the N samples of acceleration data being greater than a threshold; and
determining that the fall is on the soft surface in response to the variance from the N samples of acceleration data after applying the high-pass filter on the N samples of acceleration data being less than the threshold.

9. The method of claim 8, further comprising detecting the free-fall event by a finite state machine circuit of a sensor of the electronic device.

10. The method of claim 9, where the determining that the fall is on the hard surface or the soft surface comprises determining by a machine learning core of the sensor, the method further comprising communicating surface type of the fall to a processor of the electronic device.

11. The method of claim 10, wherein the finite state machine circuit and the machine learning core are always ON, wherein the finite state machine circuit communicates the free-fall event detection to the machine learning core, and, in response, the machine learning core determines whether the fall is on the hard surface or the soft surface.

12. The method of claim 10, wherein the finite state machine circuit is always ON and the machine learning core is initially in low-power mode, wherein the finite state machine circuit communicates the free-fall event detection to the processor, and, in response, the electronic device enables the machine learning core and the machine learning core determines whether the fall is on the hard surface or the soft surface.

13. The method of claim 10, wherein the sensor can change device configurations independently from the processor, wherein the finite state machine circuit is always ON and the machine learning core is initially in low-power mode, wherein, in response to the finite state machine circuit detecting the free-fall event, the finite state machine circuit enables the machine learning core and the machine learning core determines whether the fall is on the hard surface or the soft surface.

14. The method of claim 8, wherein the threshold is stored in a memory storage of the electronic device, the threshold being configurable.

15. A sensor of an electronic device, the sensor comprising:
an accelerometer configured to collect acceleration data;
a finite state machine circuit configured to receive the acceleration data from the accelerometer and detect a free-fall event; and
a machine learning core, in response to detecting the free-fall event, configured to:
calculate a number of crossing events from N samples of acceleration data collected after the free-fall event, the number of crossing events corresponding to a number of times an acceleration norm calculation for each sample of the N samples exceeds a first threshold,
determine that a fall of the electronic device is on a hard surface in response to the number of crossing events being greater than a second threshold, and
determine that the fall is on a soft surface in response to the number of crossing events being less than the second threshold.

16. The sensor of claim 15, wherein the machine learning core is further configured to communicate surface type of the fall to a processor of the electronic device.

17. The sensor of claim 16, wherein the finite state machine circuit and the machine learning core are always ON, wherein the finite state machine circuit communicates the free-fall event detection to the machine learning core, and, in response, the machine learning core determines whether the fall is on the hard surface or the soft surface.

18. The sensor of claim 16, wherein the finite state machine circuit is always ON and the machine learning core is initially in low-power mode, wherein the finite state machine circuit communicates the free-fall event detection to the processor, and, in response, the electronic device enables the machine learning core and the machine learning core determines whether the fall is on the hard surface or the soft surface.

19. The sensor of claim 16, wherein the sensor can change device configurations independently from the processor, wherein the finite state machine circuit is always ON and the machine learning core is initially in low-power mode, wherein, in response to the finite state machine circuit detecting the free-fall event, the finite state machine circuit enables the machine learning core and the machine learning core determines whether the fall is on the hard surface or the soft surface.

20. The sensor of claim 15, wherein the first threshold and the second threshold are stored in a memory storage of the electronic device, the first threshold and the second threshold being configurable threshold values.
